(19) United States
(12) Patent Application Publication
(10) Pub. No.: US 2023/0320279 A1
(43) Pub. Date: Oct. 12, 2023

(54) SYSTEM AND A METHOD FOR AUTOMATED PROCESSING OF A PLANT

(71) Applicant: Yehezkel HENKIN, Tel-Aviv (IL)

(72) Inventor: Yehezkel HENKIN, Tel-Aviv (IL)

(21) Appl. No.: 18/295,436

(22) Filed: Apr. 4, 2023

Related U.S. Application Data
(60) Provisional application No. 63/329,426, filed on Apr. 10, 2022.

(51) Int. Cl. A01G 3/00; G06T 7/00; G01N 21/47

(52) U.S. Cl. CPC A01G 3/002; G06T 7/001; G01N 21/4795

(57) ABSTRACT

A system and a method for automated sorting and trimming a plant. The system includes a trimming station, adapted to identify undesired portions of the plant, and to trim the undesired portions off the plant. The system may further include a guiding assembly adapted to ensure that the plant is aligned with the trimming station. A controller controls operation of the trimming station and of the guiding assembly. The system may further include a sorting station adapted to determine whether the plant is infected or contaminated. The controller may be adapted to control operation of the sorting station.

### REFERENCE TO RELATED APPLICATIONS

The present application gains priority from US Provisional Patent Application No. 63/329,426 filed Apr. 10, 2022 and entitled A SYSTEM AND A METHOD FOR AUTOMATED SORTING, TRIMMING, AND TREATING OF A PLANT, which is incorporated by reference as if fully set forth herein.

### FIELD OF THE INVENTION

The present invention relates to systems and methods for automated processing of plants, and specifically to systems and methods for automated sorting of plants to identify infested or bad portions, trimming desired or undesired portions of the plants, and further treating or processing of the desired portions of the plant

### BACKGROUND OF THE INVENTION

Many plants, require pruning or trimming in order to improve their growth, the yield, or in the utilization process of the plant.

For example, cannabis plants include a central stem, having large fan leaves, buds (also termed cola), and small leaves (also termed sugar leaves) interspersed within the buds. The buds of the cannabis plant are used for medicinal and recreational purposes, while the leaves are typically removed. Additionally, the buds are unsuitable for use if they are infected with molds or other pathogens, so that infected buds are also removed.

To date, sorting of infected cannabis buds, as well as trimming of usable, or high quality, buds from the cannabis plant, are carried out manually. This job is extremely time consuming and error prone, and has a steep learning curve of the worker learning to identify infected buds. Additionally, when infected buds are identified, it is hard for a human worker to identify the level of infection, and if the bud, or part of the bud, can still be salvaged. This often results in discarding of any bud that has some level of infection, even though it is possible that the bud would still be usable.

Trimming of infected or damaged portions of the plant, or pruning of the plant, is also useful for processing of other plants, such as myrtle and dates. Often, processing of plants, such as myrtle and dates, is carried out in the field or in a greenhouse.

There is thus a need in the art for a system and method for automatically identifying infected portions of a plant, and for trimming the plant to separate between desired portions of the plant and undesired or infected portions of the plant.

### SUMMARY OF THE INVENTION

The present invention relates to systems and methods for automated sorting, trimming, and processing or treating of plants.

In accordance with an embodiment of the present invention, there is provided a system for automated sorting and trimming a plant, the system including:
a trimming station, adapted to identify undesired portions of the plant, and to trim the undesired portions off the plant;
a guiding assembly adapted to ensure that the plant is aligned with the trimming station; and
a controller, adapted to control operation of the trimming station, and the guiding assembly.

In some embodiments, the system further includes a sorting station adapted to determine whether the plant is infected or contaminated. In some embodiments, the controller is adapted to control operation of the sorting station.

In some embodiments, the guiding assembly is adapted to guide the system between rows of growing plants, and to align the system with the plant for trimming thereof.

In some embodiments the plant is a cut plant, and the guiding assembly includes a clasp and is adapted to guide the plant, clasped within the clasp, to be aligned with the sorting station or the trimming station.

In some embodiments, the system further includes a loading station, at which the clasp is accessible to a human operator for the human operator to load the plant into the clasp.

In some embodiments, the system further includes an automated loading station, at which the plant is automatically loaded into the clasp.

In some embodiments, the system further includes a clasp cleaning station, adapted to apply a flow of a pressurized fluid onto the clasp for release of the plant from the clasp and/or for cleaning of the clasp from residue left by the plant.

In some embodiments, the system further includes a garbage collection element, functionally associated with the trimming station, the garbage collection assembly adapted to collect at least trimmed portions of the plant.

In some embodiments, the system further includes a product collection assembly adapted to collect the plant, or portions thereof, following trimming of the plant.

In some embodiments, the system further includes a user interface, functionally associated with the controller, the user interface adapted to receive output from the controller and to present the output in a method perceivable by a human operator, or to receive control-input from a human operator and to provide the control-input to the controller for control of at least one component of the system.

In some embodiments, the system further includes at least one additional treatment station, wherein the guiding assembly is adapted to automatically guide the clasp holding the plant from the trimming station to the at least one additional treatment station. In some embodiments, the additional treatment station includes a sterilization station, adapted to sterilize the plant following trimming thereof. In some embodiments, the additional treatment station includes a dehydration station, adapted to dehydrate the plant following trimming thereof. In some embodiments, the additional treatment station includes a distilling station, adapted to distill an extract of the plant following trimming thereof.

In some embodiments, the system further includes a contaminated garbage collection element functionally associated with the sorting station. When the sorting station identifies the plant as being infected or contaminated, the guiding assembly is adapted to dispose of the plant into the contaminated garbage collection element.

In some embodiments, the sorting station is adapted to identify specific portions of the plant which are infected or contaminated, and the trimming station is adapted to identify and trim, as some of the undesired portions, the specific portions of the plant which are infected or contaminated.

In some embodiments, the sorting station includes a spectrophotometry assembly adapted to identify a spectral signature of an infector or contaminant of the plant.

In some embodiments, the sorting station includes: at least one light source adapted to emit light at predetermined wavelengths; and at least one light sensor adapted to sense light at the predetermined wavelengths, the sorting station being adapted to identify a light absorption, reflection, or refraction signature of an infector or contaminant of the plant.

In some embodiments, the sorting station includes a radiometry assembly adapted to identify a radiation signature of an infector or contaminant of the plant.

In some embodiments, the sorting station includes a luminescence activating and sensing assembly adapted to identify a luminescence signature of an infector or contaminant of the plant.

In some embodiments, the sorting station includes a thermal mapping assembly adapted to identify a heat signature of an infector or contaminant of the plant.

In some embodiments, the sorting station includes an ultrasound assembly adapted to identify a visual or ultrasound signature of an infector or contaminant of the plant.

In some embodiments, the sorting station includes an electronic sniffing assembly adapted to identify a chemical signature of an infector or contaminant of the plant.

In some embodiments, the sorting station includes at least one millimeter-wave sensor adapted to capture a three-dimensional image of the plant, wherein the processor is adapted to identify, in the three-dimensional image, contaminated tissue of the plant or tissue of an infector or contaminant of the plant.

In some embodiments, the sorting station includes:
a cuvette including a light source and a light sensor;
an air-flow mechanism adapted, when the plant is at the sorting station, to draw an air sample from the vicinity of the plant into the cuvette,
wherein the light source is adapted to emit light through the cuvette, when the air sample is disposed in the cuvette, and the light sensor is adapted to receive the light, and
wherein the controller is adapted to identify, based on a fraction of the emitted light received by the light sensor, presence of air-borne molecules in the air sample indicative of the presence of a contaminant or infector in the plant.

In some embodiments, the trimming station includes:
at least one imaging device, adapted to capture at least one image of the plant, when the plant is at the trimming station;
a laser, adapted to emit a laser beam to trim the plant at a location on the plant; and
a laser pointing assembly adapted to bring the laser to point to a three-dimensional location facilitating trimming of the plant at the specific location,
wherein the controller is adapted to process the at least one image of the plant to identify an undesired portion of the plant and to identify a location at which the undesired portion is detachable from a remainder of the plant as the specific location.

In some embodiments, the controller includes a distributed control system including at least one dedicated station controller functionally associated with at least one of the sorting station and the trimming station, and a central controller adapted to provide control input to, or to coordinate operation of, the at least one dedicated station controller.

There is further provided, in accordance with some embodiments of the disclosed technology, a sorting station for automatically identifying whether a plant is infected or contaminated, the sorting station including:
a cuvette including a light source and a light sensor;
an air-flow mechanism adapted, when the plant is at the sorting station, to draw an air sample from the vicinity of the plant into the cuvette; and
a controller functionally associated with the light source and the light sensor,
wherein the light source is adapted to emit light through the cuvette, when the air sample is disposed in the cuvette, and the light sensor is adapted to receive the light, and
wherein the controller is adapted to identify, based on a fraction of the emitted light received by the light sensor, presence of air-borne molecules in the air sample indicative of the presence of a contaminant or infector in the plant.

There is additionally provided, in accordance with some embodiments of the disclosed technology, a method for automatically sorting and trimming a plant, the method including:
aligning at least a portion of a plant processing system with the plant;
following the aligning, automatically determining whether the plant is infected or contaminated;
using imaging processing techniques, automatically identifying undesired portions of the plant; and
automatically trimming the undesired portions off the plant.

In some embodiments, aligning comprises moving the plant processing system between rows of plants, to align the plant processing system with the plant to be processed.

In some embodiments, aligning comprises loading the plant into a clasp, and moving the clasp with the plant held therein to be aligned with a portion of the plant processing system for automatically determining and automatically trimming.

In some embodiments, the loading includes manually loading the plant into the clasp. In some embodiments, the loading includes automatically loading the plant into the clasp.

In some embodiments, the method further includes, following the trimming, applying a flow of a pressurized fluid onto the clasp for release of the plant from the clasp and/or for cleaning of the clasp from residue left by the plant.

In some embodiments, the method further includes at least one of:
presenting output, relating to the determining, the identifying, or the trimming, in a method perceivable by a human operator; and
receiving control-input from the human operator and controlling at least one of the loading, the determining, the identifying, and the trimming, based on the control-input.

In some embodiments, the method further includes, additionally treating the plant, following trimming thereof and prior to release of the plant from the clasp. In some embodiments, the additionally treating includes sterilizing the plant following trimming thereof. In some embodiments, the additionally treating includes dehydrating the plant following trimming thereof. In some embodiments, the additionally treating includes distilling an extract of the plant following trimming thereof.

In some embodiments, the method further includes, in response to the determining concluding that the plant is infected or contaminated, disposing of the plant into a contaminated garbage collection element, and cleaning of the clasp.

In some embodiments, the automatically determining include identifying specific portions of the plant which are infected or contaminated; and the trimming include trimming, as some of the undesired portions, the specific portions of the plant which are infected or contaminated.

In some embodiments, the determining includes using spectrophotometry, identifying a spectral signature of an infector or contaminant of the plant.

In some embodiments, the determining includes:
emitting light at a predetermined wavelength;
sensing light at the predetermined wavelength; and
identifying in the sensed light a light absorption, reflection, or refraction signature of an infector or contaminant of the plant.

In some embodiments, the determining includes using radiometry, identifying a radiation signature of an infector or contaminant of the plant.

In some embodiments, the determining includes:
activating and sensing luminescence in the plant; and
identifying in the sensed luminescence a luminescence signature of an infector or contaminant of the plant.

In some embodiments, the determining includes a thermally mapping the plant, thereby to identify a heat signature of an infector or contaminant of the plant.

In some embodiments, the determining includes imaging the plant using an ultrasound assembly, and identifying a visual or ultrasound signature of an infector or contaminant of the plant.

In some embodiments, the determining includes, using an electronic sniffing assembly, identifying a chemical signature of an infector or contaminant of the plant.

In some embodiments, the determining includes:
capturing at least one three-dimensional image of the plant; and
identifying, in the at least one three-dimensional image, contaminated tissue of the plant or tissue of an infector or contaminant of the plant.

In some embodiments, the determining includes:
drawing an air sample from the vicinity of the plant into a cuvette;
emitting light through the cuvette, when the air sample is disposed in the cuvette;
using a light sensor, receive the light emitted through the cuvette; and
identifying, based on a fraction of the emitted light received by the light sensor, presence of air-borne molecules in the air sample indicative of the presence of a contaminant or infector in the plant.

In some embodiments, the trimming includes:
capturing at least one image of the plant;
identifying, in the at least one image, an undesired portion of the plant;
identifying, in the at least one image, a specific trimming location at which the undesired portion is detachable from a remainder of the plant;
mobilizing a laser to be at a three-dimensional location facilitating emitting a laser beam toward the specific trimming location; and
emitting a laser beam to trim the undesired portion from the plant at the specific trimming location.

### BRIEF DESCRIPTION OF THE FIGURES

The foregoing discussion will be understood more readily from the following detailed description of the invention, when taken in conjunction with the accompanying FIGS. 1A-9), in which:

FIGS. 1A, 1B, and 1C are, respectively, a block diagram and schematic illustrations of a system for automated sorting and trimming of plants according to embodiments of the disclosed technology;

FIG. 2 is an enlarged illustration of sorting stations and trimming stations forming part of the system of FIG. 1B according to an embodiment of the disclosed technology;

FIG. 3 is an exploded view illustration of a clasp forming part of a guiding assembly of the system according to an embodiment of the disclosed technology;

FIG. 4 is a perspective illustration of a guiding assembly for use in the system of FIG. 1B according to an embodiment of the disclosed technology, including the clasp of FIG. 3;

FIGS. 5A and 5B are, respectively, a perspective view illustration and a sectional view illustration of a sorting station forming part of the system of FIG. 1B according to an embodiment of the disclosed technology;

FIG. 5C is a schematic flow chart of a method of operation of the sorting station of FIGS. 5A and 5B, according to an embodiment of the disclosed technology;

FIGS. 6A and 6B are perspective view illustrations of a trimming station forming part of the system of FIG. 1B according to an embodiment of the disclosed technology;

FIG. 6C is a schematic flow chart of a method of operation of the trimming station of FIGS. 6A and 6B, according to an embodiment of the disclosed technology;

FIG. 7 is a flow chart of a method of sorting, trimming, and processing a plant according to an embodiment of the disclosed technology;

FIG. 8 is a block diagram of a system for automated sorting and trimming of plants according to embodiments of the disclosed technology; and

FIG. 9 is a flow chart of a method of sorting, trimming, and processing a plant according to an embodiment of the disclosed technology.

### DESCRIPTION OF THE PREFERRED EMBODIMENTS

The principles of the inventive system and method for sorting, trimming, and treatment of plants, may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

For the purposes of the present disclosure, a plant stem is considered to be “right side up” when it is placed in the orientation of its growth, i.e. with leaves and buds facing upwards and the stem pointing downwards, and is considered to be “upside down” which it is in the orientation opposite the natural orientation of its growth, i.e. with leaves and buds facing downwards, and the stem facing upwards.

For the purposes of the present disclosure, the term “substantially” is defined as “at least 90% of” or “within 10% deviation of”.

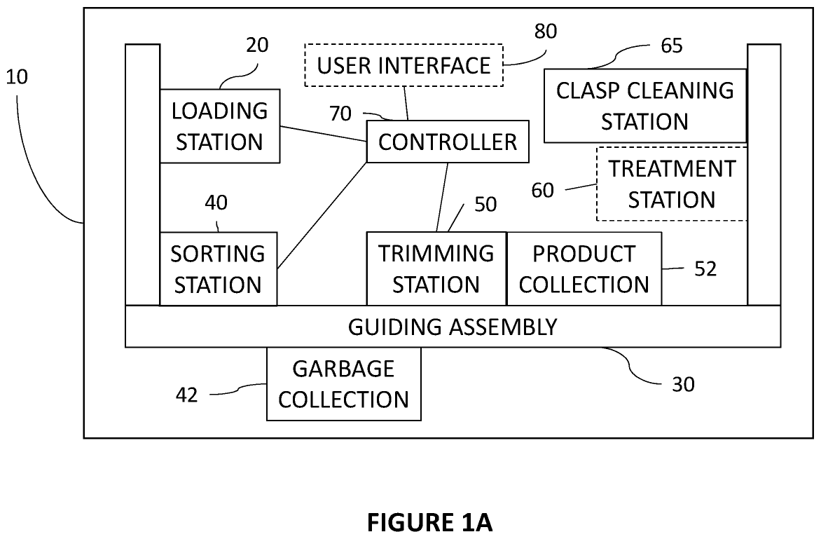

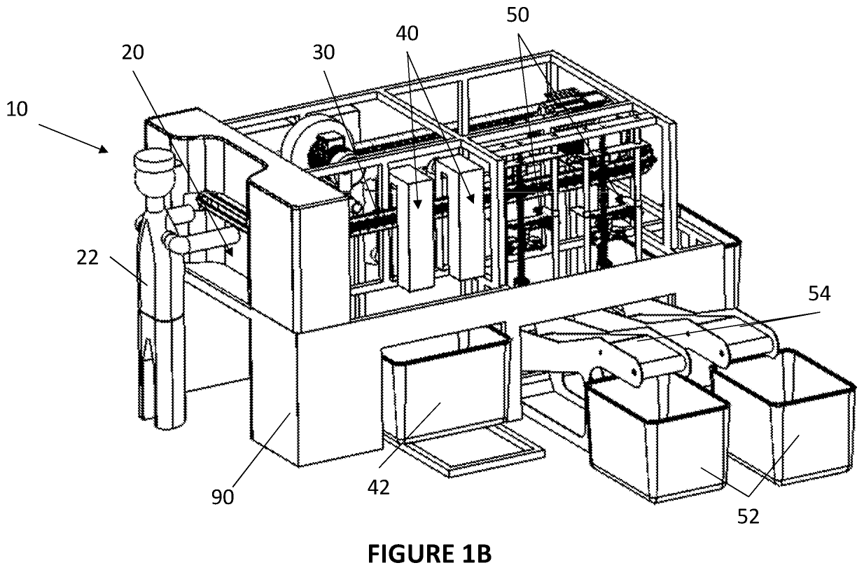

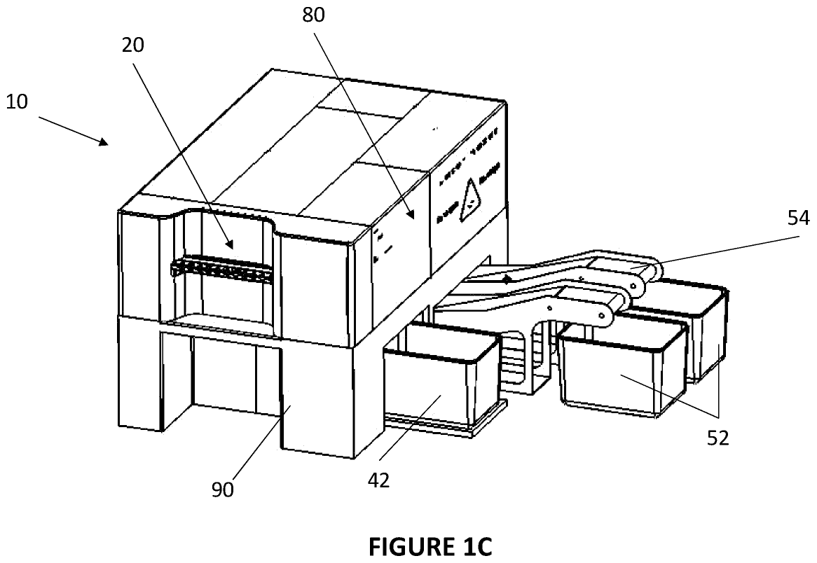

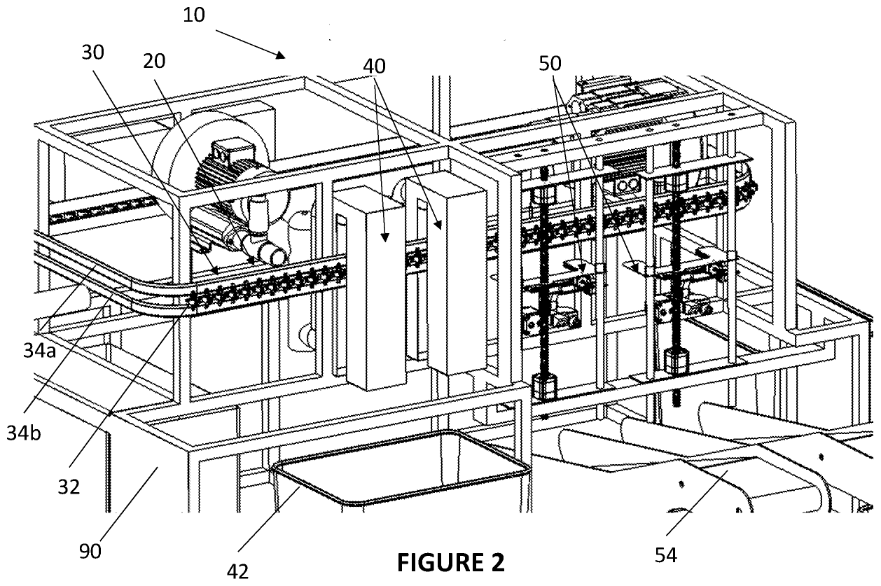

Reference is now made to FIGS. 1A, 1B, and 1C which are, respectively, a block diagram and schematic illustrations of a system for automated sorting and trimming of plants according to embodiments of the disclosed technology, and to FIG. 2, which is an enlarged illustration of sorting stations and trimming stations forming part of the system of FIG. 1B according to an embodiment of the disclosed technology.

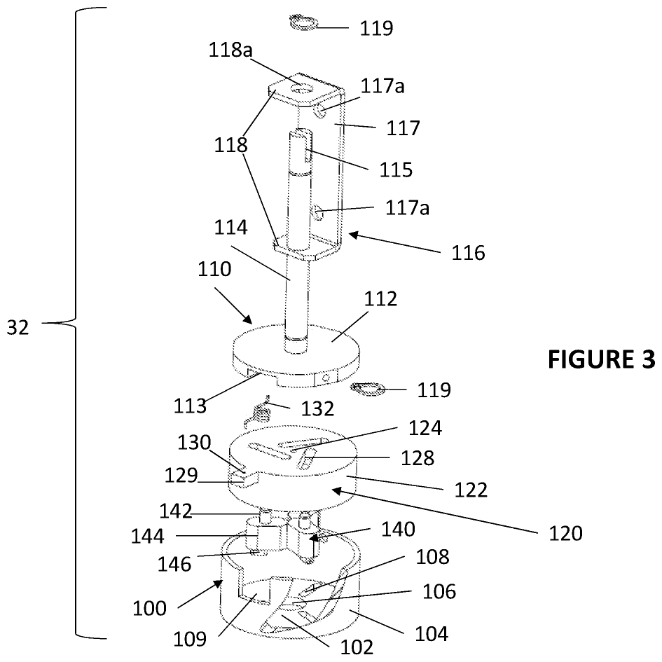

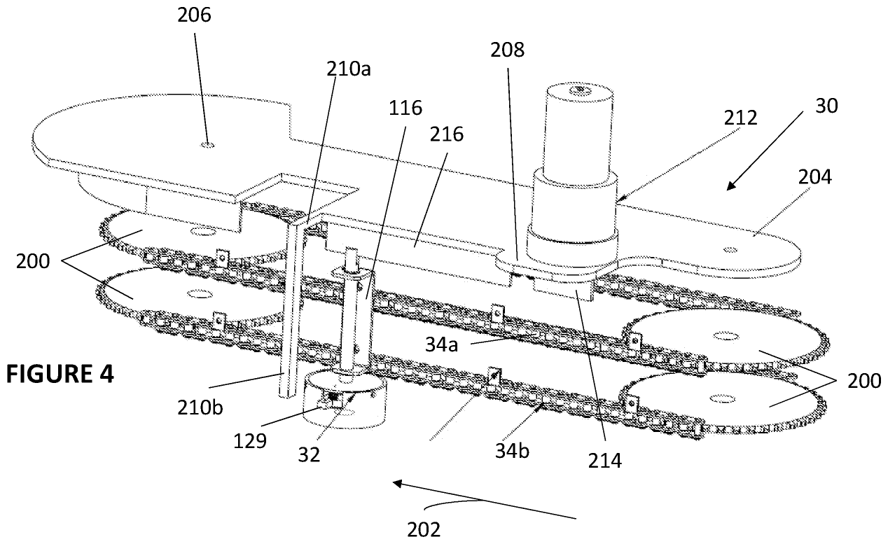

System 10 includes a loading station 20, typically operated by a human operator 22 shown in FIG. 1B. At loading station 20, plants to be sorted, trimmed, and processed are loaded into clasps 32 of a guiding assembly 30 of the system, which are described in further detail hereinbelow with respect to FIGS. 3 and 4. Clasps 32 are clearly seen in FIG. 2. As seen in FIG. 2, guiding assembly includes a plurality of clasps 32, mounted between a pair of conveyors 34a and 34b.

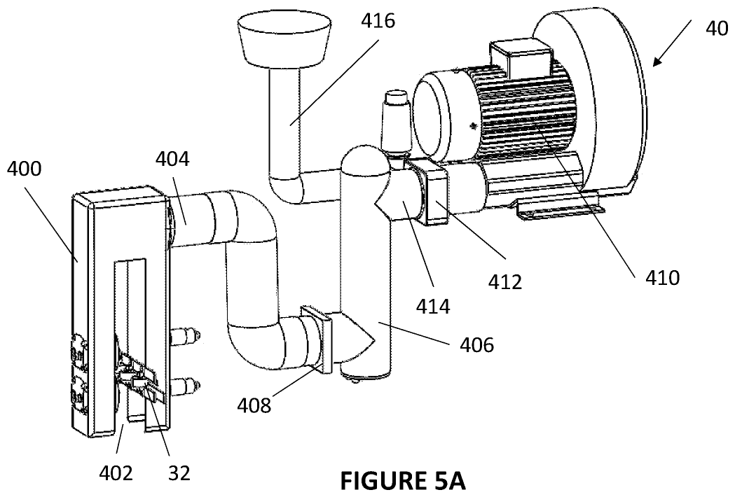

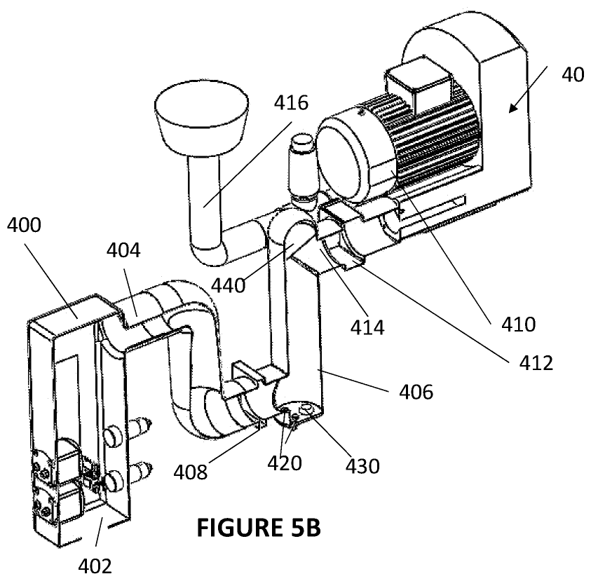

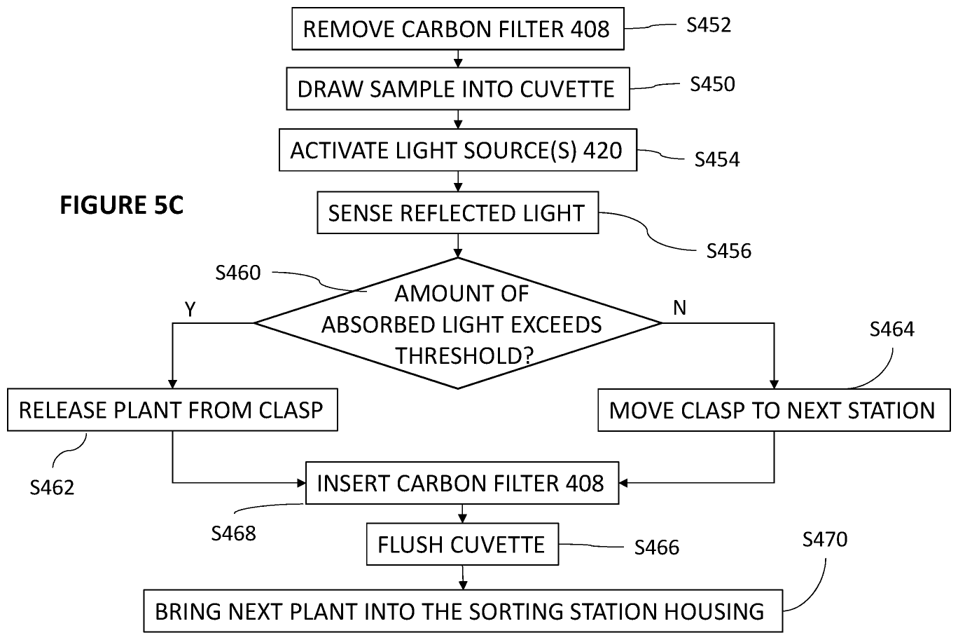

Guiding assembly 30 guides the plants disposed within the clasps to one or more sorting stations 40. For example, FIG. 1B illustrates two sorting stations 40. At sorting station(s) 40, the plants are sorted into good quality plants and poor quality plants. In some embodiments, poor quality plants are released from sorting station(s) 40 into a garbage collection element 42, such as a suitable bin. In some embodiments, the sorting station(s) 40 may sort the plants based on the presence of mold or other pathogens. The sorting station(s) 40 may use any known technique for sorting the plants, including, but not limited to, spectrophotometry, measurement of light absorption values, measurement of reflection or refraction of light at different wavelengths, radiometry, measurement of luminescence, electronic sniffing, ultrasound mapping of plant tissue, and/or thermal mapping of plant tissue. An example of a color reflection/absorption based sorting station is described hereinbelow with respect FIGS. 5A to 5C.

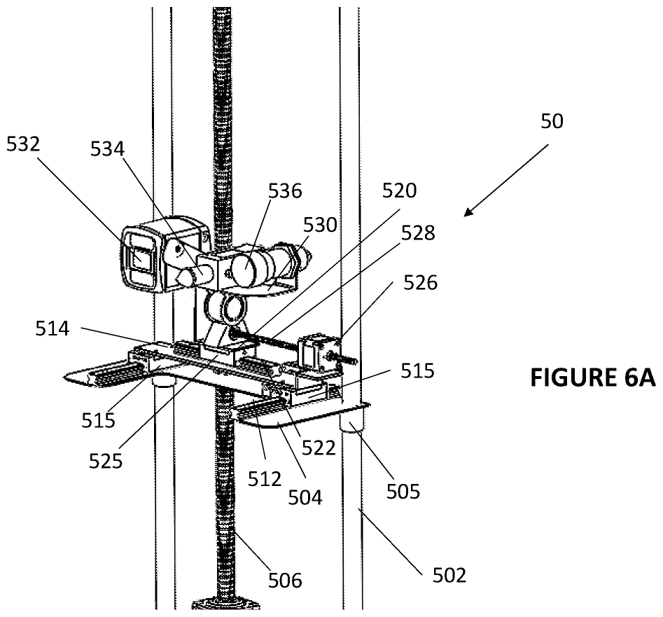

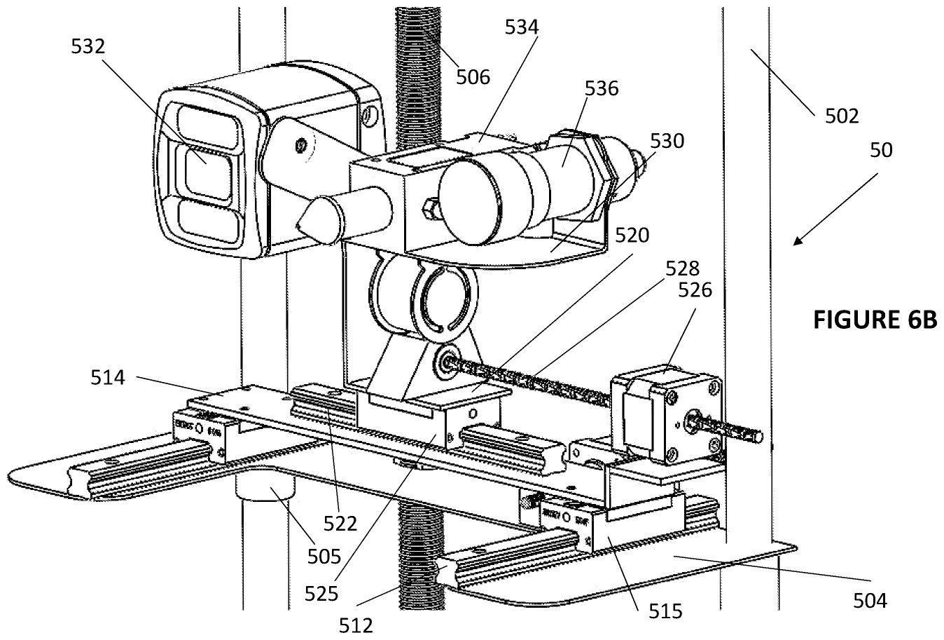

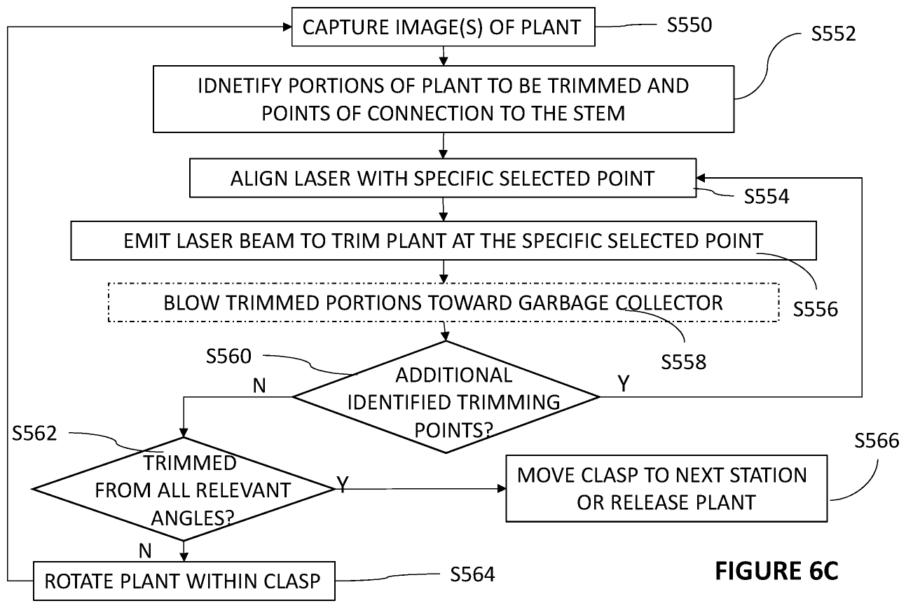

From sorting station(s) 40, guiding assembly 30 guides the plants to one or more trimming stations 50, which are described in further detail hereinbelow with respect to FIGS. 6A to 6C.

In some embodiments, undesired portions of the plant may be trimmed from the stem at trimming station(s) 50, for example into garbage collection element 42. In such embodiments, the plants may remain held by the clasps of guiding mechanism 30, and guiding mechanism 30 may guide the trimmed plants to one or more treatment stations 60, for further treatment thereof.

The treatment station(s) 60 may include any one or more of a sterilizing station, a dehydration station, and an extraction or distilling station.

For example, a sterilizing station may include sterilizing by ozone, or peroxide fogging which may replace the prior art sterilizing by beta rays in a dedicated facility. In some embodiments, the plant may pass through a sterilizing station prior to arriving at a dehydration station or at an extraction or distilling station.

Following treatment at the treatment station(s) 60, or following trimming at the trimming station 50 (e.g. if no treatment station is required, as shown in FIG. 1B), the plants are transferred to a product collection element 52, such as a suitable bin, for use. In some embodiments, a conveying mechanism, such as conveyor belts 54 shown in FIG. 1B, transfer the trimmed or treated plants from trimming station 50 or treatment station 60 to product collection bin 52.

In some embodiments, a further trimming station separates the buds from the stem held in the clasp, such that the buds fall into product collection element 52 and the stems fall into garbage collection element 42. In other embodiments, the removal of the buds from the stems may be carried out after removal of the plants from system 10, for example manually.

In some other embodiments, trimming station(s) remove desired portions of the plant, such as healthy buds, from the stem, directly into the product collection element 52, such as a suitable bin. In some such embodiments, the product collection element 52, including trimmed product stored therein, may be transferred to the treatment station(s) 60, for further treatment of the trimmed plant portions.

Typically, the system further includes a clasp cleaning station 65, to which the clasp is transported following completion of trimming and/or treatment of a specific plant, prior to having another plant placed therein. The clasp cleaning station 65 may be adapted to ensure that the plant has been released from the clasp, and to clean the clasp following release of the plant. For example, clasp cleaning station 65 may have a pressurized fluid flow through the clasp, to blow the plant out of the clasp (if the plant was somehow stuck in the clasp) and to remove any residue the plant left on the clasp, such as sap, oil, and the like.

A controller 70 is functionally associated with guiding assembly 30, sorting station(s) 40, trimming station(s) 50, treatment station(s) 60, and clasp cleaning station(s) 65. Controller 70 is adapted to control and coordinate operation of all the various stations, and, if necessary, to facilitate communication of information between one station and another. In some embodiments, system 10 may further include a user interface 80, enabling human operator 22 to interact with controller 70. User interface 80 may include an output interface, such as a screen, on which the human operator may view information about system 10. User interface 80 may include an input interface, such as a touch pad or a keyboard, with which the human operator may provide information to, program, or otherwise control operation of controller 70 and of components of system 10. User interface 80 may also be disposed on a separate device, such as a mobile or cellular phone running a suitable application. In such embodiments, the inputs provided by the human operator, using the mobile device, may be wirelessly transmitted to controller 70.

The term “controller” as used herein means a computing device configured for monitoring, controlling, regulating and/or actuating one or more components, assemblies, stations, systems, or subsystems. A controller should be understood to include any or all of (and not exhaustively): one or more processors, one or more computer-readable media, e.g., transient and/or non-transient storage media, communications arrangements, a power source and/or a connection to a power source, and firmware and/or software. Controllers can be programmed in advance, e.g., by having program instructions stored in the computer-readable media for execution by one of more processors of the controller. Thus, a controller ‘configured’ to perform a function is equivalent herein to the controller being programmed, i.e., having access to stored program instructions for execution, to perform the function.

In some embodiments, guiding assembly 30, sorting station(s) 40, trimming station(s) 50, treatment station(s) 60, and controller 70 may be disposed within a housing structure 90. In some embodiments, the guiding assembly 30 is disposed on an exterior of housing structure 90 only in loading station 20, to enable the operator 22 to access the guiding assembly for loading thereof. However, in other embodiments, loading of plants into loading station 20 may be automatic, in which case the loading station 20 need not be exposed. The use of manual or automatic loading may depend on the scale of the plant trimming operation.

Typically, user interface 80 would be disposed on an exterior of housing structure 90, or in a place accessible to the human operator. Furthermore, garbage collection element 42 and product collection element 52 must also be easily accessible to a human operator, for removal and emptying thereof. As seen in FIG. 1B, the two collection elements may be bins disposed in openings of housing 90, enabling user access thereto.

Reference is now made to FIG. 3, which is an exploded view illustration of a clasp 32 which may form part of a guiding assembly 30 suitable for use in system 10, according to an embodiment of the disclosed technology. It is to be appreciated that the clasp 32 shown in FIG. 3 is an exemplary clasp, and many other types of clasp may be suitable for use in system 10.

As seen in FIG. 3, clasp 32 includes a housing portion 100 having a base 102 surrounded by a partial circumferential wall 104 (which is partially cut-away in the Figure).

Base 102 includes a central bore 106, adapted to receive the stem of a plant therein, and a plurality of slots 108. Circumferential wall 104 includes a recess 109, adapted to receive a release tab, as explained in further detail hereinbelow.

Clasp 32 further includes a cover portion 110, including an upper base 112 and defining a recess 113. Upper base 112 is fixedly attached to, and may be integrally formed with, a longitudinal rod 114, disposed at the center of upper base 112. Disposed at an upper end of longitudinal rod 114 is a slot 115, extending horizontally through the rod. A connector bracket 116 includes a longitudinal segment 117 having a pair of bores 117a adapted for connection to conveyors of the guiding assembly 30. A pair of transverse segments 118 extend outwardly from longitudinal segment 117. Each of segments 118 includes a corresponding bore 118a, adapted to receive rod 114 therein. Rod 114 is adapted to be held in a fixed position relative to connector bracket 116 by annular clamps 119, disposed above and below segments 118 along rod 114.

A clasping assembly 120 is adapted to be disposed within housing portion 100 and to be rotatable relative thereto. Clasping assembly 120 includes a base disc 122 having formed therein a central bore 124, and a plurality of slots 128, disposed about central bore 124 at pre-determined angles relative to each other. In the illustrated embodiment, slots 128 form a triangle. As will be explained in further detail hereinbelow, slots 128 are adapted to function as cams for motion of clasping elements of the clasping assembly.

A release tab 129 extends radially outwardly from base disc 122, near an upper edge of the disc. Release tab 129 is adapted to be disposed between recesses 109 and 113, and to be circumferentially movable with the limits of the recesses. Release tab 129 includes a bore 130, adapted to receive an end of a spring 132. The opposing end of spring 132, is adapted to be received within upper base 112, thereby connecting the base disc to the upper base.

Clasping assembly 120 further includes a plurality of clasping elements 140, each including a substantially oval body portion 142. A first prong 144 extends out of body portion 142, in an upward direction, and is adapted to be slidably disposed within a corresponding slot 128. A second prong 146 extends out of body portion 142, in a downward direction, and is adapted to be slidably disposed within a corresponding slot 108 of housing portion 100.

In a closed operative mode of clamp 32, spring 132 biases base disc 122, such that its orientation relative to base 102 causes the first prongs 144 to be disposed close to central bore 124, within slots 128. In this orientation, body portions 142 of the clasping elements are biased toward one another, so as to engage and clasp an item disposed between the body portions, such as a stem of a plant. The item, or stem, may be inserted into the clasp via lower bore 106.

When releasing tab 129 is rotated relative to housing portion 100, against the biasing of spring 132, prongs 144 of the clasping elements slide along slots 128 to locations in the slots further from central bore 124, thereby creating a distance between body portions 142. In this arrangement, the item held between the body portions is released, and can drop out of the clasping assembly via bore 106.

It is a particular feature of the present implementation of clasp 32 that the stem of the plant is held at the center of the clasp. As such, when the clasp is rotated about its longitudinal axis, the stem of the plant remains in a substantially fixed position, subject to natural irregularities in the structure of the stem.

Reference is now additionally made to FIG. 4, which is a perspective illustration of a guiding assembly 30 according to an embodiment of the disclosed technology, including a three clasp 32 as described hereinabove with respect to FIG. 3. It is to be appreciated that the guiding assembly illustrated in FIG. 4 is an exemplary implementation, and other suitable implementations of guiding assemblies are considered within the scope of the present invention. The main characteristics, or functionalities, that the guiding must have, include the ability to rotate the clasp 32 relative to its longitudinal axis, to enable access all portions of a plant held within the clasp, and the ability to release the plant from the clasp. Additionally, the guiding assembly may include an active mechanism for releasing the plant from clasp 32, such as a prong that can be pushed downward to a limited degree in order to push the plant downward and out of the clasp, or a fluid flow that pushes the stem out of the clasp, and can also clean the clasp, as described with respect to clasp cleaning station 65.

As seen, clasp 32, and particularly bracket 116 thereof, is mounted between conveyors 34a and 34b. The conveyors are arranged about suitable gears 200, which move the conveyors and accordingly guide the clasp between stations of the system.

In the embodiment of FIG. 4, the conveyors move from right to left, in the direction of arrow 202.

A plate 204 is disposed vertically above conveyors 34a and 34b, and includes bores 206 for connection to an axis of gears 200. A protrusion 208 of plate 204 extends outwardly of conveyors 34a and 34b at a first point along the conveyors. At a second point along the conveyors, an L-shaped appendage including a horizontal portion 210a and a vertical portion 210b extends outwardly of plate 204 and downwardly toward the lower conveyor 34b, leaving a space between the vertical portion 210b and the conveyors.

A motor 212 is disposed upwardly of plate 204, above protrusion 208 thereof. Motor 212 is functionally associated with a fin 214, extending downwardly from plate 204 and outwardly to conveyors 34a and 34b. Typically, motor 212 is disposed adjacent a trimming station 50, as explained herein. When motor 212 is operative, fin 214 is adapted to rotate relative to plate 204. An elongate bar 216 is extends downwardly from plate 204, substantially along conveyors 34a and 34b.

In use, when clasp 32 is disposed beneath protrusion 208, fin 214 is disposed within slot 115 of rod 114. In this arrangement, activation of motor 212 causes clasp 32, and the plant held therein, to be rotated relative to the plate, relative to bracket 116, and relative to the trimming station 50, to facilitate trimming of the plant from all directions. Following trimming of the plant, the motor continues to rotate until fin 214 is again aligned with conveyors 34a and 34b.

Additional motion of the conveyors guides clasp 32 in the direction of arrow 202, such that bar 216 is disposed within slot 115, and rotation of clasp 32 relative to the conveyors is prevented. When clasp 32 is in the orientation shown in FIG. 4, and passes L-shaped appendage, the vertical portion 210b presses against and rotates the releasing tab 129 relative to the housing of clasp 32, causing the plant to be released, as explained hereinabove.

In cases in which it is undesireable to release the plant, motor 212 may rotate fin 214 such that clasp 32 is arranged at 180 degrees relative to the orientation shown in FIG. 4, with releasing tab 129 facing toward conveyors 34a and 34b. In this arrangement, vertical portion 210b would not engage the releasing tab, and the plant would remain within clasp 32.

In some embodiments, an L-shaped appendage and/or a motor 212 and fin 214 as shown may also be associated with a sorting station. In such embodiments, a plant that is determined to be contaminated, may be released from the system immediately following the sorting station 40, without going through the trimming station 50.

Reference is now made to FIGS. 5A and 5B, which are, respectively, a perspective view illustration and a sectional view illustration of a sorting station 40 according to an embodiment of the disclosed technology.

It is to be appreciated that the description of FIGS. 5A, 5B, and 5C relates to a specific example of a sorting station, using a technique of identifying the absorption of color in air borne molecules surrounding the plant. However, as discussed hereinabove with respect to FIGS. 1A and 1B, many other types of sorting stations suitable for detecting infected plants are considered within the scope of the present invention, such as spectrometry sorting stations, ultrasound imaging sorting stations, heat imaging sorting stations, spectrophotometry sorting stations, radiometry sorting stations, and luminescence-based sorting stations.

As seen in FIGS. 5A and 5B, sorting station 40 includes a housing structure 400 defining an opening 402. Conveyors 34a and 34b, carrying clasps 32 having plants therein, extend through opening 402 of the sorting station, for sorting of a plant held in each such clasp.

Housing 400 is in fluid communication with a pipe 404, here shown as a bent pipe, which is in fluid communication with a substantially linear cuvette pipe 406. In some embodiments, a carbon filter 408 may be selectively disposed along pipe 404, either close to housing 402 or close to cuvette pipe 406, as shown. As explained in further detail hereinbelow, carbon filter 408 may be used to ensure that the cuvette is flushed clean between sorting of multiple plants.

Cuvette 406 is in fluid communication with an air-flow mechanism 410, adapted to draw air from housing 402, via pipe 404 into cuvette 406. A second carbon filter 412, disposed between cuvette 406 and air-flow mechanism 410 along a pipe line 414, ensures that contaminants are kept out of the air-flow mechanism. Pipe 414 may be in fluid communication with an exhaust pipe 416, for release of filtered air from sorting station 40.

In some embodiments, air-flow mechanism 410 may include a blower, a suction mechanism, or any other suitable mechanism causing air flow from housing 402 to cuvette 406.

Disposed at a base of cuvette 406 are a plurality of light sources 420, adapted to emit light in a plurality of colors, or wavelengths. In some embodiments, the light sources 420 may include LED lights. In some embodiments, at least some of light sources 420 are adapted to emit light in the visible spectrum. In some embodiments, at least some of light sources 420 are adapted to emit light in the infra-red spectrum. In some embodiments, at least some of light sources 420 are adapted to emit light in the ultra-violet spectrum.

One or more light sensors 430 are also disposed at the base of cuvette 406, and are adapted to sense light in the wavelengths emitted by light sources 420. A reflector 440, such as a mirror, is disposed at a top of cuvette 406 and is adapted to re-direct light from light sources 420 toward the light sensor. However, in some embodiments, light sensor 430 may be disposed at or near the top of cuvette 406 and reflector 440 may be obviated, as explained in further

Turning to FIG. 5C, the flow chart thereof illustrates a method of using sorting station 40 of FIGS. 5A and 5B to identify the presence of mold, or other contaminants, in a specific plant held in a specific clasp 32 disposed within station 40. The operation of sorting station 40 is controlled by controller 70 (FIG. 1A) or by a dedicated controller, for example disposed within housing 400. If such a dedicated controller is provided, the dedicated controller may be in communication with controller 70, to receive instructions from and provide information to the central controller 70.

When clasp 32 with the plant held therein is disposed within opening 402 of housing 400, at step S450, air-flow mechanism 410 is activated to draw an air sample from opening 402 and the vicinity of the plant held therein, through pipe 404 into cuvette 406. Prior to drawing in the air sample, at step S452, carbon filter 408 may be electronically and automatically removed from the flow path between opening 402 and cuvette 406. As such, the air sample drawn into cuvette 406 would include any air-borne molecules present in the vicinity of the plant within the housing.

Once the air sample is disposed within cuvette 406, light sources 420 are activated to emit light into the cuvette at step S454, and light reflected by reflector 440 is collected, or sensed, by light sensor(s) 430 at step S456. For each wavelength emitted by light sources 420, the controller identifies a quantity of the emitted light that was absorbed by the air sample within the cuvette, and did not reach light sensor(s) 430=. The wavelengths emitted by light sources 420 are selected to be ones that are absorbed by molecules emitted by contaminants of the plant, such as molecules emitted by mold growing on the plant. Thus, the quantity of absorbed light in these wavelengths is indicative of the presence of mold, or other contaminants, on the plant.

At step S460, the controller evaluates whether the amount of absorbed light exceeds a pre-defined threshold, which is indicative of an undesireable, or unacceptable, quantity of contaminants. For example, the acceptable quantity of contaminants, or contaminant threshold, for a specific plant and for a specific contaminant, may be selected according to a botanical standard or a medical standard, and may be a local standard or an international standard.

If the controller identifies that the amount of absorbed light is indicative of an unacceptable contamination level, at step S462, the plant may be released from clasp 32, toward the garbage collection element, substantially as described hereinabove with respect to FIGS. 6A to 6C. Otherwise, if the light absorption is indicative of a clean, or sufficiently uncontaminated, plant, at step S464 conveyors 34a and 34b may move the clasp 32 holding the plant along, toward the trimming station.

At step S466, which occurs following removal of the plant from housing 400 and prior to sorting of another plant, cuvette 406 is flushed with clean air, drawn by air-flow mechanism 410 via pipe 404. In some embodiments, prior to flushing of the cuvette, carbon filter 408 is automatically inserted back into the flow-path between housing 402 and cuvette 406 at step S468, to ensure that the air flushing the cuvette is clean and does not introduce additional contaminants.

Following flushing of the cuvette, at step S470, conveyors 34a and 34b move another clasp, holding another plant to be sorted, into housing 400, and the flow returns to step S452.

It is to be appreciated that the sorting station of FIGS. 5A and 5B, and the method of use thereof as described in FIG. 5C, makes a binary decision regarding an entire plant—is the plant usable or not. By contrast, some other sorting stations may be more sensitive, and make decisions about each specific bud, or each portion of the plant, whether or not it is usable. In some such embodiments, information from the sorting station, indicating contaminated portions of the plant to be trimmed, or good portions of the plant to be kept, maybe transmitted from the sorting station to the trimming station, for appropriate trimming of the plant. Use of this type of sorting station would maximize the plant material that is used, as it would ensure use of non-contaminated portions of a partially contaminated plant.

In some embodiments, sorting station 40 may use a different sorting technique. For example, sorting station 40 may include one or more millimeter wave sensors, adapted to generate a 3D image of the plant. The processor (or a dedicated processor) may then process the 3D image, to identify differences in the tissue between healthy plant tissue and contaminated tissue, or tissue of contaminants. For example, molds are keratinous, and plants are cellulose based, two structures which are readily distinguishable in 3D images.

Reference is now made to FIGS. 6A and 6B, which are perspective view illustrations of an exemplary trimming station 50 according to an embodiment of the disclosed technology.

As seen in FIGS. 6A and 6B, a mobilization assembly 500 has mounted thereon a base 520, and is adapted to move the base 520 along the x-, y-, and z-axes. Specifically, mobilization assembly includes a first pair of guides 502, extending along the vertical, or z-axis direction. Guides 502 have a platform 504 slidably mounted thereon by mounts 505. Platform 504 is adapted to be mobilized up and down along guides 502 by a dedicated motor associated with a threaded bar 506.

Mounted onto platform 504 are a second pair of guides 512, extending along the depth, or y-axis direction. Guides 512 have a platform 514 slidably mounted thereon by mounts 515. Platform 514 is adapted to be mobilized forward and backward along guides 512 by one or more dedicated motors.

Mounted onto platform 514 is a third guide 522, extending along the width, or x-axis direction. Guide 522 has base 520 slidably mounted thereon by a mount 525. Base 520 is adapted to be mobilized right and left along guide 522 by a dedicated motor 526 associated with a threaded bar 528.

Base 520 has mounted thereon an operative platform 530, carrying an imaging device 532, adapted to capture an image of a plant held within a clasp 32, and a laser light source 534, adapted to trim the plant at a specific point identified by image processing of the captured image of the plant. In some embodiments, operative platform may include a second imaging device or a sensor 536.

Imaging device 532 may be any suitable type of imaging device, including a stills camera, a three-dimensional camera, a video camera, a thermal imaging camera, or any other type of camera.

Laser light source 534 may be any type of laser emitting a beam suitable for cutting plant matter, such as a solid-state laser, a gas laser, a fiber laser, or a semi-conductor laser. In some embodiments, laser light source 534 emits a coherent laser beam. In some embodiments, laser light source 534 comprises a CO₂ laser.

In some embodiments, trimming station 50 may further include a blower (not explicitly shown), adapted to blow trimmed portions of the plant toward the garbage collection element.

Turning to FIG. 6C, the flow chart thereof illustrates a method of using trimming station 50 of FIGS. 6A and 6B to identify undesired portions of a specific plant held in a specific clasp 32 disposed across from station 50, and trim those portions off the stem. The operation of trimming station 50 is controlled by controller 70 (FIG. 1A) or by a dedicated controller, for example disposed on operative platform 530 or on base 520. If such a dedicated controller is provided, the dedicated controller may be in communication with controller 70, to receive instructions from and provide information to the central controller 70.

When clasp 32 with the plant held therein is disposed, in a first orientation, in front of trimming station 50, at step S550, imaging device 532 is activated to capture one or more images of the plant. In some embodiments, in which station 50 includes a second imaging device 536, it too is activated to capture one or more images of the plat at this step.

At step S552, the controller processes the image(s) captured at step S550, to identify portions of the plant that should be trimmed, and the points at which those portions are connected to the stem of the plant. For example, when trimming cannabis plants, the controller may identify points at which leaves, whether palm leaves or sugar leaves, are connected to the stem or to the plant, which points would be suitable for cutting or trimming of the leaves.

At step S554, a specific such identified point is selected, and the controller mobilizes base 520 such that laser light source 532 is directly parallel to the selected point. The laser light source 532 is activated to emit a laser beam for trimming the plant at the identified point at step S556. In some embodiments, the blower may be activated at step S558, to blow the trimmed portions of the plant toward the garbage collection element.

Subsequently, at step S560, the controller evaluates whether there are additional identified trimming points identified at step S552, which have not yet been trimmed by the laser. If there are such additional identified trimming points, the flow returns to step S554 for selection of another point for trimming.

If there are no additional trimming points that have been identified and haven't been treated, at step S562 the controller evaluates whether the plant has been trimmed from all relevant angles. If the plant has not been trimmed from all relevant angles, at step S564 the controller controls guiding assembly 30 to rotate clasp 32, and the plant held therein, relative to the imaging device 532 and laser 534, substantially as described hereinabove with respect to FIGS. 6A to 6C. The flow then returns to step S550 for imaging and trimming of the plant in the new orientation. Otherwise, if the plant has been fully trimmed, at step S566 conveyors 34a and 34b may move the clasp 32 holding the plant along, toward the treatment station, or, if no additional processing is required, the stem including the desired portions may be released from clasp 32 into the product collection element, substantially as described hereinabove. At this stage, trimming station 50 is ready to receive and trim an additional plant.

In some embodiments, in which the sorting station 40 identifies specific portions of the plant that are infected or contaminated and must be trimmed, and other portions of the plant that may be used, the information generated by the sorting station is provided to the controller controlling the trimming station. The information received from the sorting station is used during the image processing at step S552, and the controller identifies portions to be trimmed and points of trimming also based on the information received from the sorting station.

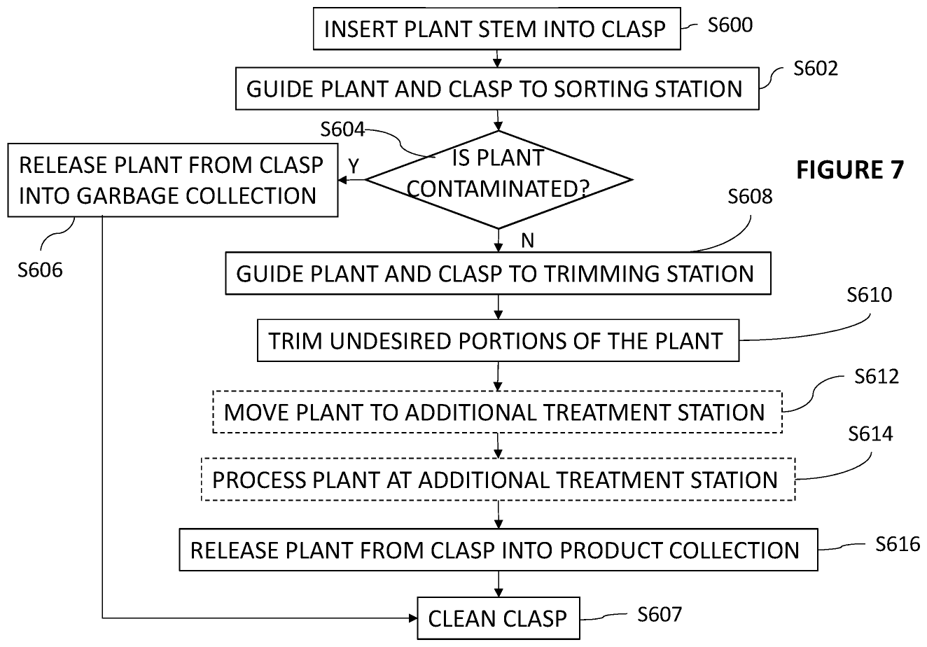

Reference is now made to FIG. 7, which is a flow chart of a method of sorting, trimming, and processing a plant according to an embodiment of the disclosed technology, for example using system 10. The method is described with respect to a single plant or plant stem, but would typically be implemented for multiple plant stems.

At step S600, a human operator inserts the plant stem into a clasp mounted onto a guiding or conveying assembly, such as clasp 32 of guiding assembly 30 of FIGS. 3 and 4. At step S602, a controller, such as controller 70, moves the guiding assembly to have the clasp holding the plant reach a sorting station, such as sorting station 40 of FIGS. 5A and 5B.

At step S604, the processor, or a dedicated sorting station processor, determines whether the plant is infected or contaminated, for example as described hereinabove with respect to FIG. 5C. In some embodiments, the sorting station not only determines whether or not the plant is infected, but also identifies which portions of the plant are infected, or which portions of the plant are usable. If the plant is infected, and is determined to be useless, at step S606 the plant is released from clasp 32 into a garbage collection element, and processing of the plant has ended. Subsequently, the clasp is cleaned, for example at clasp cleaning station 65, at step S607.

Otherwise, if the plant, or at least portions thereof, are determined to be useful, at step S608 the guiding assembly moves the plant to a trimming station for trimming of undesired portions of the plant, such as trimming station 50 of FIGS. 6A and 6B. At step S610, which takes place in the trimming station, the undesired portions of the plant are trimmed, for example as described hereinabove with respect to FIG. 6C.

In some embodiments, in which the system includes one or more additional treatment stations, such as a sterilizing station, a dehydration station, and/or a distilling station, at step S612 the guiding assembly moves the plant to the additional treatment station(s), and at step S614 the plant is processed at those stations, for example using sterilizing methods, dehydration methods, and/or distilling methods as known in the art.

If no additional treatment station is included, or following processing at the additional processing system, at step S616 the plant is released from clasp 32 into a product collection element. In some embodiments, either immediately before step S616 or following that step, the plant undergoes additional processing operations, such as removing desired portions of the plant from the stems. In some embodiments, an additional trimming station 50 may be used for removal of the desired portions of the plant from the stems.

Subsequently, the clasp is cleaned, for example at clasp cleaning station 65, at step S607.

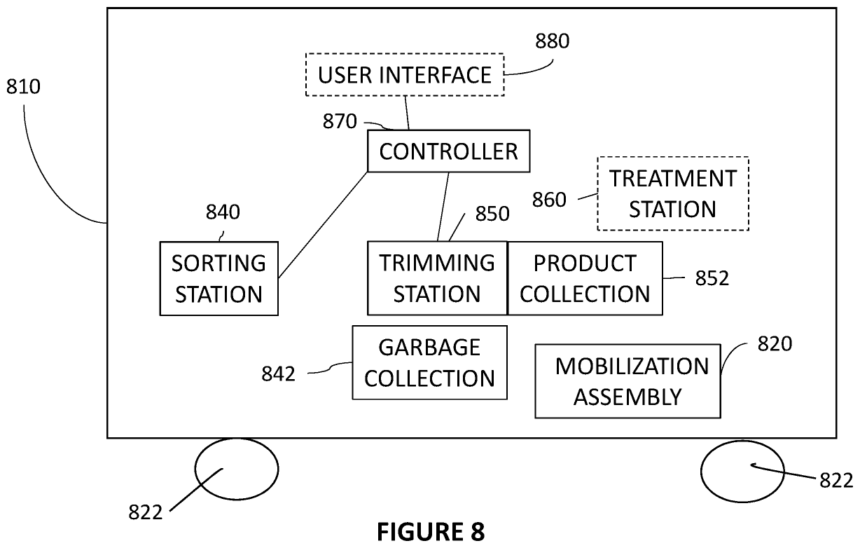

Reference is now made to FIG. 8, which is a block diagram and schematic illustrations of a system 810 for automated processing of plants according to embodiments of the disclosed technology. System 810 is substantially similar to system 10 described hereinabove with respect to FIGS. 1A to 2. The main distinction between system 810 and previously described system 10 is that in system 10, the plant is a cut plant, and is moved between different stations of the system by the guiding assembly 30. By contrast, system 810 is a mobile system, designed to sort and trim plants in the field or in a greenhouse, by moving between the rows of plants and aligning itself with each plant for processing thereof. As such, the plants are not loaded into the system obviating the need for loading station 20. Further, the guiding assembly of system 810 is actually a mobilization assembly 820, for example including a motor associated with wheels 822, for mobilizing the system between plants.

Mobilization assembly 820 guides system 810 between the plants, to align each of sorting station 840, trimming station(s) 850, treatment station(s) 860, and cleaning station 865 with each selected plant. Sorting station 840 may function similarly to sorting station 40 described hereinabove, with the distinction that the plants that are not processed remain attached to the ground (or the substrate on which they are growing). In some such embodiments, garbage collection element 42 of system 10 may be obviated.

Trimming station(s) 850 function substantially as described hereinabove, with the distinction that the parts of the plant being trimmed are connected to a plant still growing from a substrate. In some embodiments, undesired portions of the plant may be trimmed from the stem at trimming station(s) 850, for example into garbage collection element 842.

In some embodiments, the treatment station(s) 860 may be dedicated to treatment of plants that are still growing, such as providing treatment against pests or plant diseases.

In some embodiments, in which the trimmed portions are desired products (such as automatically trimming ripe fruit from the plant), the product may be collected at product collection element 852, such as a suitable bin, for use.

A controller 870 is functionally associated with mobilization assembly 820, sorting station(s) 840, trimming station(s) 850, and/or treatment station(s) 860, substantially as described hereinabove. In some embodiments, system 810 may further include a user interface 880, enabling a human operator to interact with controller 870, substantially as described hereinabove.

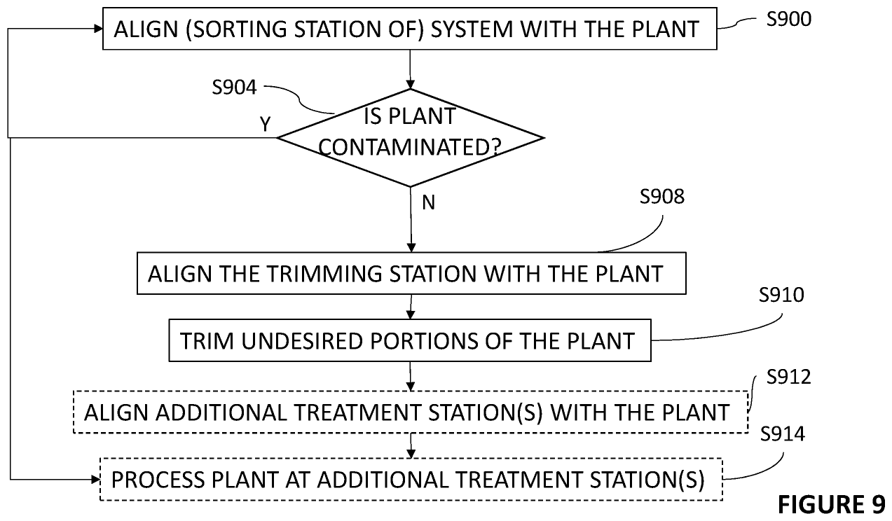

Reference is now made to FIG. 9, which is a flow chart of a method of processing a plant according to an embodiment of the disclosed technology, for example using system 810. The method is described with respect to a single plant growing in a row of plants, but would typically be implemented for multiple plant in the row or in multiple rows of plants.

At step S900 mobilization assembly 820 guides system 810 between the rows of plants, to be aligned with a specific plant to be processed. Operation of mobilization assembly 820 may be accomplished by a human operator, e.g. “driving” the system using user interface 880, or may be accomplished automatically by controller 870. In some embodiments, controller 870 may have a navigation tool (e.g. be aware of coordinates, e.g. using GPS) or a map of the field or greenhouse in which the system working, and guides the system based on the navigation tool or map. For example, in some embodiments, the sorting station 840 of system 810 may be aligned with the plant.

At step S904, the processor, or a dedicated sorting station processor, may determine whether the specific plant to which the system was guided is infected or contaminated, for example as described hereinabove with respect to FIG. 5C, mutatis mutandis. In some embodiments, the sorting station not only determines whether or not the plant is infected, but also identifies which portions of the plant are infected, or which portions of the plant are usable. If the plant is infected, and is determined to be useless, the flow returns to step S900 for guiding of the system to the next plant to be processed.

Otherwise, if the plant, or at least portions thereof, are determined to be useful, at step S908 the trimming station is aligned with the plant for trimming of undesired portions of the plant. At step S910, the undesired portions of the plant are trimmed, for example as described hereinabove with respect to FIG. 6C, mutatis mutandis.

In some embodiments, in which the system includes one or more additional treatment stations, at step S912 the system is moved such that the additional treatment station(s) 860 are aligned with the plant, and at step S914 the plant is processed at those stations.

If no additional treatment station is included, or following processing at the additional processing system, the flow returns to step S900 for navigating to the next plant to be processed.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. Similarly, the content of a claim depending from one or more particular claims may generally depend from the other, unspecified claims, or be combined with the content thereof, absent any specific, manifest incompatibility therebetween.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A system for automated processing of a plant, the system comprising:
a sorting station adapted to determine whether the plant is infected or contaminated;
a trimming station, adapted to identify undesired portions of the plant, and to trim said undesired portions off the plant;
a guiding assembly adapted to ensure that the plant is aligned with said sorting station or with said trimming station; and
a controller, adapted to control operation of said sorting station, said trimming station, and said guiding assembly.

2. The system of claim 1, wherein said guiding assembly is adapted to guide said system between rows of growing plants, to align said system with said plant, for trimming thereof.

3. The system of claim 1, wherein said plant is a cut plant, and wherein said guiding assembly includes a clasp and is adapted to guide the plant, clasped within said clasp, to be aligned with said trimming station.

4. The system of claim 3, further comprising a loading station, at which said clasp is accessible to a human operator for the human operator to load the plant into said clasp.

5. The system of claim 3, further comprising an automated loading station, at which the plant is automatically loaded into said clasp.

6. The system of claim 3, further comprising a clasp cleaning station, adapted to apply a flow of a pressurized fluid onto said clasp for release of the plant from said clasp and/or for cleaning of said clasp from residue left by the plant.

7. The system of claim 1, further comprising a garbage collection element, functionally associated with said trimming station, said garbage collection assembly adapted to collect unwanted trimmed portions of the plant.

8. The system of claim 1, further comprising a product collection assembly adapted to collect the plant, or portions thereof, following trimming of the plant.

9. The system of claim 3, further comprising at least one additional treatment station, wherein said guiding assembly is adapted to automatically guide said clasp holding the plant from said trimming station to said at least one additional treatment station.

10. The system of claim 9, wherein said additional treatment station comprises at least one of:
a sterilization station, adapted to sterilize the plant following trimming thereof;
a dehydration station, adapted to dehydrate the plant following trimming thereof; and
a distilling station, adapted to distill an extract of the plant following trimming thereof.

11. The system of claim 1, wherein said sorting station is adapted to identify specific portions of the plant which are infected or contaminated, and wherein said trimming station is adapted to identify and trim, as some of said undesired portions, said specific portions of the plant which are infected or contaminated.

12. The system of claim 1, wherein said sorting station comprises at least one of:
(a) a spectrophotometry assembly adapted to identify a spectral signature of an infector or contaminant of the plant;
(b) an assembly including:
at least one light source adapted to emit light at predetermined wavelengths; and
at least one light sensor adapted to sense light at said predetermined wavelengths,
wherein said sorting station is adapted to identify a light absorption, reflection, or refraction signature of an infector or contaminant of the plant;
(c) a radiometry assembly adapted to identify a radiation signature of an infector or contaminant of the plant;
(d) a luminescence activating and sensing assembly adapted to identify a luminescence signature of an infector or contaminant of the plant;
(e) a thermal mapping assembly adapted to identify a heat signature of an infector or contaminant of the plant;
(f) an ultrasound assembly adapted to identify a visual or ultrasound signature of an infector or contaminant of the plant;
(g) an electronic sniffing assembly adapted to identify a chemical signature of an infector or contaminant of the plant; and
(h) at least one millimeter-wave sensor system adapted to capture a three dimensional image of the plant, wherein said processor is adapted to identify, in the three dimensional image, contaminated tissue of the plant or tissue of an infector or contaminant of the plant.

13. The system of claim 1, wherein said sorting station comprises:
a cuvette including a light source and a light sensor;
an air-flow mechanism adapted, when the plant is at said sorting station, to draw an air sample from the vicinity of the plant into the cuvette,
wherein said light source is adapted to emit light through said cuvette, when said air sample is disposed in said cuvette, and said light sensor is adapted to receive said light, and
wherein said controller is adapted to identify, based on a fraction of said emitted light received by said light sensor, presence of air-borne molecules in said air sample indicative of the presence of a contaminant or infector in the plant.

14. The system of claim 1, wherein said trimming station comprises:
at least one imaging device, adapted to capture at least one image of the plant, when the plant is at said trimming station;
a laser, adapted to emit a laser beam to trim the plant at a location on the plant; and
a laser pointing assembly adapted to bring said laser to point to a three-dimensional location facilitating trimming of the plant at said specific location,
wherein said controller is adapted to process said at least one image of the plant to identify an undesired portion of the plant and to identify a location at which said undesired portion is detachable from a remainder of the plant as said specific location.

15. The system of claim 1, wherein said controller comprises a distributed control system including at least one dedicated station controller functionally associated with at least one of said sorting station and said trimming station, and a central controller adapted to provide control input to, or to coordinate operation of, said at least one dedicated station controller.

16. A sorting station for automatically identifying whether a plant is infected or contaminated, the sorting station comprising:
a cuvette including a light source and a light sensor;
an air-flow mechanism adapted, when the plant is at said sorting station, to draw an air sample from the vicinity of the plant into the cuvette; and
a controller functionally associated with said light source and said light sensor,
wherein said light source is adapted to emit light through said cuvette, when said air sample is disposed in said cuvette, and said light sensor is adapted to receive said light, and
wherein said controller is adapted to identify, based on a fraction of said emitted light received by said light sensor, presence of air-borne molecules in said air sample indicative of the presence of a contaminant or infector in the plant.

17. A method for automatically sorting and trimming a plant, the method comprising:
aligning at least a portion of a plant processing system with the plant;
following said aligning, automatically determining whether the plant is infected or contaminated;
using imaging processing techniques, automatically identifying undesired portions of the plant; and
automatically trimming said undesired portions off the plant.

18. The method of claim 17, wherein said aligning comprises moving said plant processing system between rows of plants, to align the plant processing system with the plant to be processed.

19. The method of claim 17, wherein said aligning comprises loading the plant into a clasp, and moving the clasp with the plant held therein to be aligned with a portion of the plant processing system for said automatically determining and said automatically trimming.

20. The method of claim 19, further comprising, following said trimming, applying a flow of a pressurized fluid onto said clasp for release of the plant from said clasp and/or for cleaning of said clasp from residue left by the plant.
